(19) United States
(12) Patent Application Publication
(10) Pub. No.: US 2026/0300288 A1
(43) Pub. Date: Oct. 1, 2026

(54) INFORMATION COMBINING DEVICE AND INFORMATION COMBINING METHOD

(71) Applicant: NEC Corporation, Tokyo (JP)

(72) Inventors: Tatsuya Fukuda, Tokyo (JP); Masaharu Morimoto, Tokyo (JP); Yoshiaki Sakae, Tokyo (JP); Joe Brinton, Tokyo (JP); Ryosuke Hotchi, Tokyo (JP); Masaki Inokuchi, Tokyo (JP); Sian En Ooi, Tokyo (JP); Shunsuke Osaki, Tokyo (JP)

(73) Assignee: NEC Corporation, Tokyo (JP)

(21) Appl. No.: 19/576,122

(22) Filed: Mar. 24, 2026

(30) Foreign Application Priority Data
Mar. 28, 2025 (JP) 2025-055894

(51) Int. Cl. G06F 16/2452

(52) U.S. Cl. CPC G06F 16/24528

(57) ABSTRACT

For facilitating easy execution of a combining process when combining multiple related documents, etc., to create a new document etc. using an LLM, the information combining device includes a receiving unit which accepts multiple types of data, a combination unit which combines the multiple types of data according to a rule for combining the multiple types of data, and an output unit which output combined data.

### CROSS-REFERENCE TO RELATED APPLICATION

This application is based upon and claims the benefit of priority from the Japanese Patent Application No. 2025-055894 filed on Mar. 28, 2025, the entire disclosure of which is hereby incorporated.

### BACKGROUND OF THE INVENTION

### Technical Field

The present disclosure relates to an information combining device and an information combining method using a large-scale language model.

### Background Art

Large language model (LLM) is a machine learning model whose core is natural language processing. LLMs are learning models trained using large amounts of text data. Generally, to handle a desired task, the parameters of an LLM are fine-tuned by training it on a specific dataset (for example, see Patent Document 1).

### Citation List

### Patent Literature

[Patent literature 1] Japanese Patent Application Publication No. 2024-43563

### SUMMARY OF THE INVENTION

There may be a need to generate a new document from multiple related documents, etc. To address such a need, utilizing an LLM is considered.

One example is a task of creating a new design document from an existing system design document or a similar design document and the corresponding program source code. Such a task may arise, for instance, when a system design has become outdated and needs to be updated to the latest design. Note that the content of the new design document is semantically equivalent to that of the existing design document.

Hereinafter, existing design documents may be referred to as legacy design documents or legacy documents. Existing source code may be referred to as legacy source code or legacy code. New design documents may be referred to as modern design documents or modern documents.

When using an LLM to create a modern design document based on the legacy design document and a legacy source code, that is, when appropriately combining the content of the legacy design document and the content of the legacy source code to create a modern design document, achieving this appropriate combination can be difficult. Note that "combination" means to merge. More specifically, combination means creating a single document from information contained in multiple documents.

For example, if there are discrepancies or inconsistencies between the meaning of the legacy design document and the meaning of the legacy source code, it is not possible to appropriately combine the legacy design document and the legacy source code. Further, if there are areas where the correspondence between the content of the legacy design document and the content of the legacy source code is unclear, appropriate combination becomes difficult.

Therefore, when combining the legacy design document and the legacy source code, it is necessary to input both the legacy design document and the legacy source code into an LLM, subsequently, manual comparison and review must be performed to combine the output result from the LLM for the legacy design document with the output result from the LLM for the legacy source code. Then, based on the comparison result, the integration work between the legacy design document and the legacy source code is performed manually.

The object of the present disclosure is to provide an information combining device and an information combining method that can easily execute combining processing when generating a new document, etc., by combining multiple related documents using an LLM.

The information combining device based on present disclosure includes receiving means for accepting multiple types of data, combination means for combining the multiple types of data according to a rule for combining the multiple types of data, and output means for outputting combined data.

The information combining method based on present disclosure is a method executed by a computer, accepting multiple types of data, combining the multiple types of data according to a rule for combining the multiple types of data, and outputting combined data.

The information combining program based on present disclosure causes a computer to execute accepting multiple types of data, combining the multiple types of data according to a rule for combining the multiple types of data, and outputting combined data.

According to the present disclosure, when generating a new document, etc., by combining multiple related documents using an LLM, the combination process can be easily performed.

### BRIEF DESCRIPTION OF THE DRAWINGS

FIG. 1 It depicts an explanatory diagram showing the concept of the information combining device using an LLM.

FIG. 2 It depicts a block diagram showing an example of hardware configuration of the information combining device.

FIG. 3 It depicts a block diagram showing an example of the functional blocks of the information combining device.

FIG. 4 It depicts a flowchart showing an example of the operation of the information combining device.

FIG. 5 It depicts a block diagram showing another example of the functional blocks of the information combining device.

FIG. 6 It depicts a flowchart showing another example of the operation of the information combining device.

FIG. 7 It depicts a block diagram showing yet another example of the functional blocks of the information combining device.

FIG. 8 It depicts a flowchart showing still another example of the operation of the information combining device.

FIG. 9 It depicts a block diagram showing still another example of the functional blocks of the information combining device.

FIG. 10 It depicts a flowchart showing another example of the operation of the information combining device.

FIG. 11 It depicts a block diagram showing the main part of the information combining device.

### DESCRIPTION OF THE EXAMPLE EMBODIMENTS

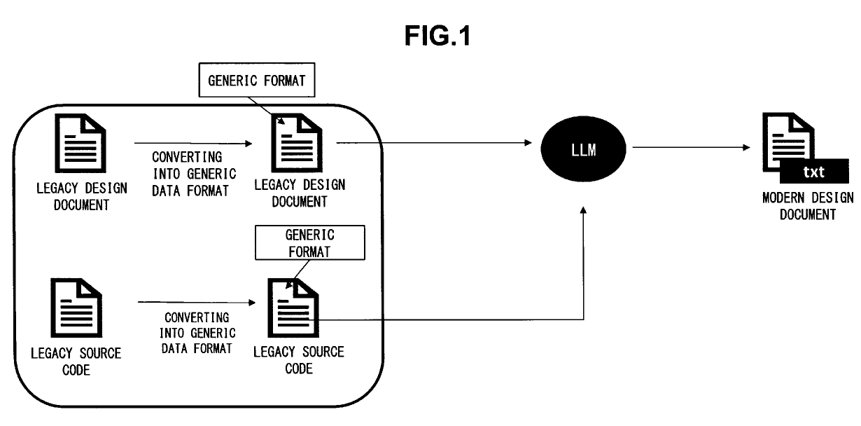

First, the concept of the present disclosure is explained. FIG. 1 is an explanatory diagram showing the concept of the information conversion device using an LLM. An example is provided where a modern design document is created based on a legacy design document and a legacy source code.

The information combining device based on present disclosure inputs a legacy design document and legacy source code whose data format has been converted to a generic (general-purpose) data format. Note that "data format " can be rephrased as the manner of data representation or the data structure. Further, the generic data format is, for example, not data format specialized for a particular purpose, and is a data format that can be easily understood and reused by many designers and others involved in system design. If necessary, the information combining device converts the data format of the legacy design document and the data format of the legacy source code into a data format that can be input to the LLM (easily processed by the LLM).

When configured such that a legacy design document and legacy source code, which have not been converted into generic data format, are input to the information combining device, the information combining device is provided with a data format conversion unit that converts the information into information in a generic data format.

In the example embodiments described below, the information combining device handles legacy design documents and legacy source code. However, the types of documents handled by the information combining device are not limited to these. The information combining device in the following example embodiments can be applied to generate a new document, etc., by combining multiple types of documents, etc., that are relevant, other than legacy design documents and legacy source code. Furthermore, the number of documents may be three or more.

Further, an example of the generic data format is a data format (data structure) utilizing the Model View Controller (MVC) architecture.

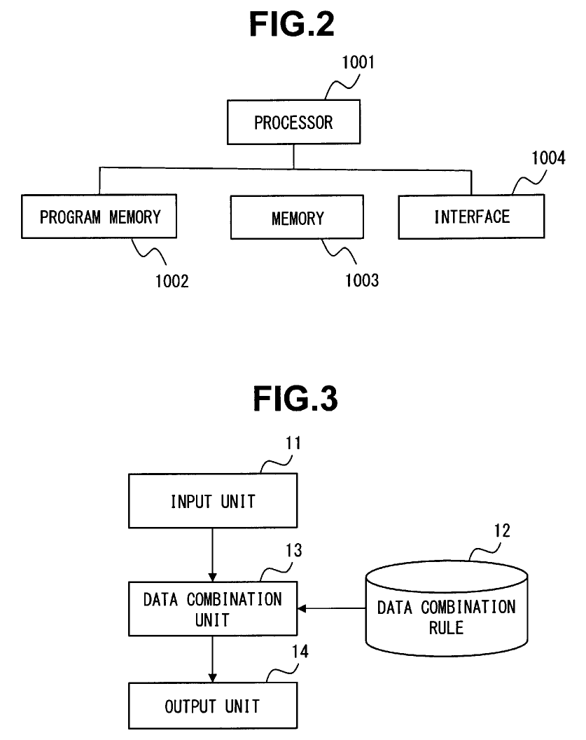

FIG. 2 is a block diagram showing an example of the hardware configuration of the information combining device. The information combining device can be implemented using an information processing device as illustrated in FIG. 2. The information processing device is, for example, a server device or a personal computer.

The information processing device illustrated in FIG. 2 includes one or more processors 1001, such as a CPU (Central Processing Unit), a program memory 1002, a memory 1003, and an interface 1004. FIG. 2 illustrates an example of an information processing device having one processor 1001.

The program memory 1002 is, for example, a non-transitory computer-readable medium. The non-transitory computer-readable medium includes various types of tangible storage media. For example, a semiconductor storage medium such as flash ROM (Read Only Memory) or a magnetic storage medium such as a hard disk can be used as the program memory 1002. The program memory 1002 stores an information combining program that implements the functions of the information combining device in each example embodiment described below.

The processor 1001 implements the functions of each block (excluding the storage) in the information combining device by executing processing according to the information combining program stored in the program memory 1002. When multiple processors are installed, multiple processors may cooperate to implement the functions of the information combining device.

The memory 1003 may, for example, utilize RAM (Random Access Memory). The memory 1003 stores temporary data generated while the information combining device is executing processing. It is also conceivable that an information combining program is transferred to the memory 1003, and the processor 1001 executes processing based on the information combining program in the memory 1003. Note that the program memory 1002 and the memory 1003 may be integrated.

Further, the semiconductor storage medium such as a flash ROM (Read Only Memory) or a magnetic storage medium such as a hard disk can be used as the memory 1003. The memory 1003 using these can realize the database in the information combining device of each example embodiment described below.

The interface 1004 is an input/output unit for inputting data such as documents or outputting processing results, either directly or through a communication line.

Hereinafter, an example embodiment of the present disclosure will be explained with reference to the drawings.

### Example embodiment 1

FIG. 3 is a block diagram showing an example of the functional blocks of the information combining device. The information combining device shown in FIG. 3 comprises an input unit 11, a data combination rule storage 12, a data combination unit 13, and an output unit 14.

The information combining device can be implemented, for example, by hardware such as that shown in FIG. 2. In that case, the input unit 11, the data combination unit 13, and the output unit 14 are implemented by the processor 1001 that executes processing according to a program and the interface 1004.

The input unit 11 inputs data such as design documents and source code (in this example embodiment and the following example embodiments, legacy design documents and legacy source code). The data combination rule storage 12 is a database storing one or more data combination rules.

The data combination unit 13 acquires a data combination rule from the data combination rule storage 12. When multiple data combination rules are stored in the data combination rule storage 12, the data combination unit 13 selects the data combination rule suitable for the design document and the source code. Then, the data combination unit 13 uses an LLM (not shown in FIG. 3) to combine the information in the design document with the information in the source code. When using the LLM, the data combination unit 13 inputs the data of the design document, the data of the source code, and the data combination rule into the LLM. The output unit 14 outputs the processing result (combination result) from the LLM.

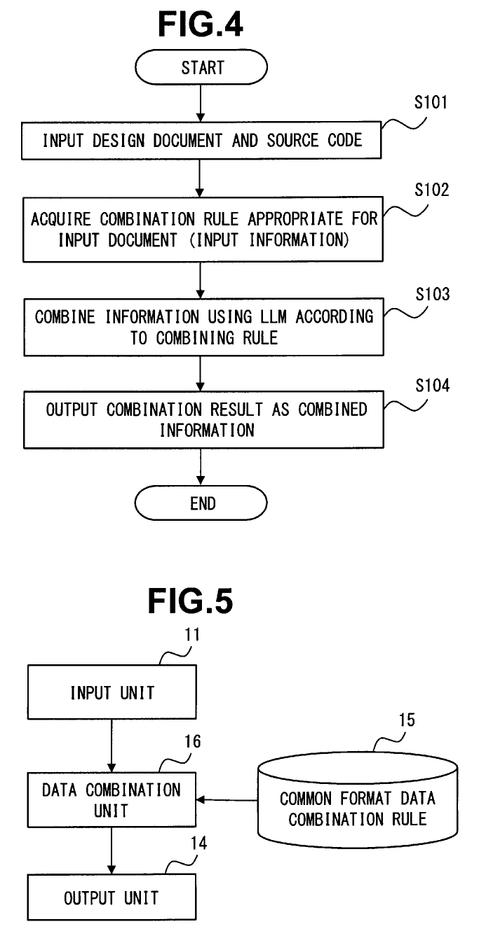

Next, the operation of the information combining device of this example embodiment will be explained with reference to FIG. 4. FIG. 4 is a flowchart showing an example of the operation of the information combining device of this example embodiment.

The input unit 11 receives input of the design document and the source code (step S101).

The data combination unit 13 acquires a data combination rule appropriate for the data format of the design document or the source code from the data combination rule storage 12 (step S102). Note that the data combination rule appropriate for the data format of the document refers, for example, to a rule consistent with the characteristic of the document being handled (text, image, diagram, etc.).

The data combination unit 13 combines the information in the design document with the information in the source code using an LLM according to the acquired combining rule (step S103). For example, the data combination unit 13 generates a combination result consisting of a set of similar or matching information from the information in the design document and the information in the source code.

The output unit 14 outputs the combination result. In this example embodiment, the combination result corresponds to a modern design document (step S104).

In this example embodiment, data of the design document and data of the source code are automatically combined according to a predetermined combination rule. Then, a document (for example, a modern design document) is acquired as the combination result.

Simply assuming that LLM is used to combine multiple documents, both the design document data and the source code data are input to the LLM for interpretation, and the resulting interpretations would be manually compared to create the combined document. In this example embodiment, manual combination work is omitted, thereby improving the efficiency of the document combination process.

### Example embodiment 2

FIG. 5 is a block diagram showing another example of the functional blocks of the information combining device. The information combining device shown in FIG. 5 comprises an input unit 11, a common format data combination rule storage 15, a data combination unit 16, and an output unit 14. The input unit 11 and the output unit 14 have the same functions as those in the first example embodiment.

The common format data combination rule storage 15 is a database storing one or more common format data combination rules. The common format data combination rules are rules for combining multiple documents having a common data structure, designed to ensure consistency between the documents. Specifically, using two documents as an example, these are combination rules that consider how to handle similarities and differences when the data structure of one document is common with that of another document.

As one example, similarities may be unconditionally reflected in the output data (output information: in this example embodiment, the modern design document), while non- similarities are not reflected in the modern design document (not included in the modern design document).

The data structure is, for example, a data structure utilizing the aforementioned MVC architecture. However, the common format data combination rule storage 15 may store combination rules corresponding to multiple types of data structures.

The data combination unit 16 acquires a common format data combination rule from the common format data combination rule storage 15. When multiple common format data combination rules are stored in the common format data combination rule storage 15, the data combination unit 16 selects a common format data combination rule suitable for the data structures of the design document and the source code. Then, the data combination unit 16 combines the information in the design document with the information in the source code using an LLM (not shown in FIG. 5). When using the LLM, the data combination unit 16 provides the LLM with the data of the design document, the data of the source code, and the common format data combination rule.

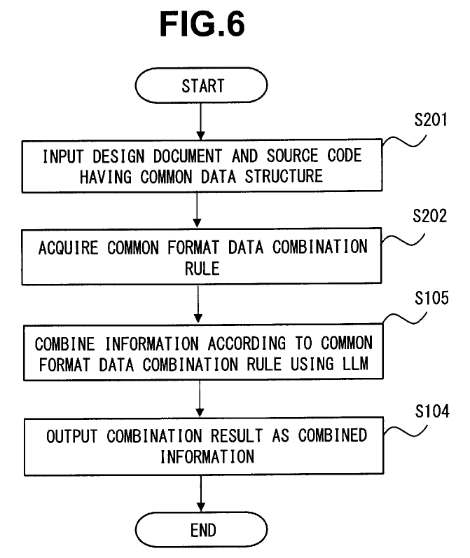

Next, the operation of the information combining device of this example embodiment will be explained with reference to FIG. 6. FIG. 6 is a flowchart showing another example of the operation of the information combining device of this example embodiment.

The input unit 11 receives input of a design document and source code having a common data structure (step S201).

The data combination unit 16 acquires a common format data combination rule corresponding to the data structure from the common format data combination rule storage 15 (step S202).

The common format data combination rules include, for example, rules specifying the handling of similarities and differences between multiple pieces of information (in this example embodiment, design documents and source code) that share a common data structure.

The common format data combination rules correspond to specific examples of the data combination rules in the first example embodiment. Furthermore, the rules defining the handling of similarities and differences can also be expressed as consistency rules.

As one example, the common format data combination rules may include a rule for combining multiple pieces of information using the data of similarities (while excluding the data of differences). Further, the common format data combination rules may include rules that, for differences, prioritize one piece of information (for example, source code) among multiple pieces of information and combine multiple pieces of information using the data in the prioritized information (the information at the point of difference within the entire information, i.e., partial information). Additionally, the common format data combination rules may include rules that do not use data of either piece of information for differences. Note that these rules are examples.

The data combination unit 16 uses an LLM to combine the information of the design document with the information of the source code according to the acquired combining rule (in this example embodiment, the common format data combination rule) (step S105). For example, the data combination unit 13 generates a combination result consisting of a set of information that is similar or identical between the information of the design document and the information of the source code.

The output unit 14 outputs the combination result. In this example embodiment, the combination result corresponds to a modern design document (step S104).

In this example embodiment, in addition to the effect of the first example embodiment, the following effect can be acquired.

Specifically, the data combination unit 16 combines the design document and the source code according to a common format data combination rule corresponding to the data structures of the design document and the source code. Therefore, even if inconsistencies exist between the data in the design document and the data in the source code, the LLM can handle them according to the common format data combination rule, enabling more appropriate combination result to be acquired from the LLM.

### Example embodiment 3

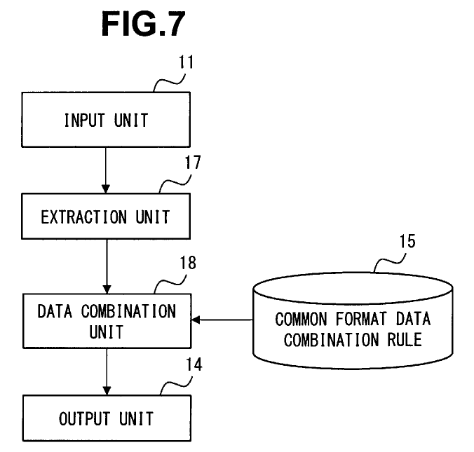

FIG. 7 is a block diagram showing yet another example of the functional blocks of the information combining device. The information combining device shown in FIG. 7 comprises an input unit 11, an extraction unit 17, a common format data combination rule storage 15, a data combination unit 18, and an output unit 14. The input unit 11, the common format data combination rule storage 15, and the output unit 14 have the same functions as those in the second example embodiment.

The information combining device can be implemented, for example, by hardware such as that shown in FIG. 2. In that case, the input unit 11, the extraction unit 17, the data combination unit 18, and the output unit 14 are implemented by the processor 100 that executes processing according to a program and the interface 1004.

The extraction unit 17 extracts similarities and differences between the design document data and the source code data. For example, when both the design document data and the source code data are text data, the extraction unit 17 can easily extract similarities and differences through text comparison. Even when the design document data and source code data are image data or diagram data, the extraction unit 17 can easily extract similarities and differences through comparison. Note that the extraction unit 17 may use general image and text extraction tools (image and text extraction applications).

The data combination unit 18 combines the design document and the source code according to a common format data combination rule using an LLM, similar to the data combination unit 16 in the second example embodiment. When combining, the data combination unit 18 considers the similarities and differences between the design document and the source code.

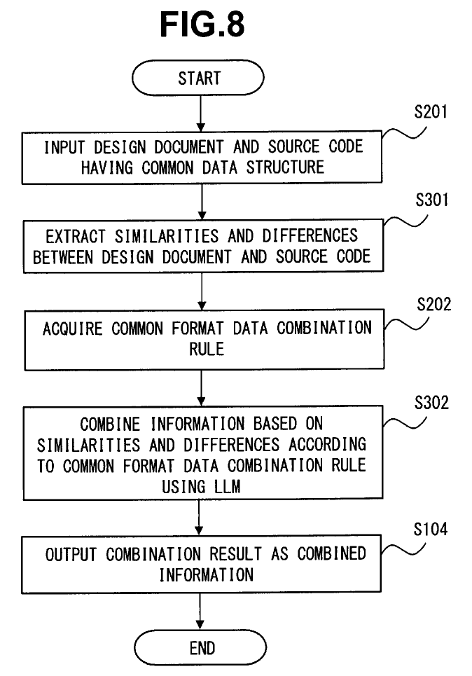

Next, the operation of the information combining device of this example embodiment will be explained with reference to FIG. 8. FIG. 8 is a flowchart showing an example of the operation of the information combining device of this example embodiment.

The processing in steps S201, S202, and S104 is the same as the processing in the second example embodiment shown in FIG. 6.

The extraction unit 17 compares the data of the design document with the data of the source code to extract similarities and differences between the design document and the source code (step S301).

The data combination unit 18 acquires a common format data combination rule from the common format data combination rule storage 15, similarly to the data combination unit 16 in the second example embodiment. Then, the data combination unit 18 combines the information of the design document with the information of the source code using an LLM (not shown in FIG. 7) (step S302). When using the LLM, the data combination unit 18 provides the LLM with the similarities and differences, the data of the design document and the data of the source code, and the common format data combination rule.

In this example embodiment, in addition to the effect of the second example embodiment, the following effect can be acquired.

Specifically, since the extraction unit 17 utilizes the LLM after identifying similarities and differences between the design document and the source code, it becomes possible to explain the reasons for selecting and rejecting partial information in the design document and the source code, and to combine multiple pieces of information (in this example embodiment, the design document and source code) with higher precision.

### Example embodiment 4

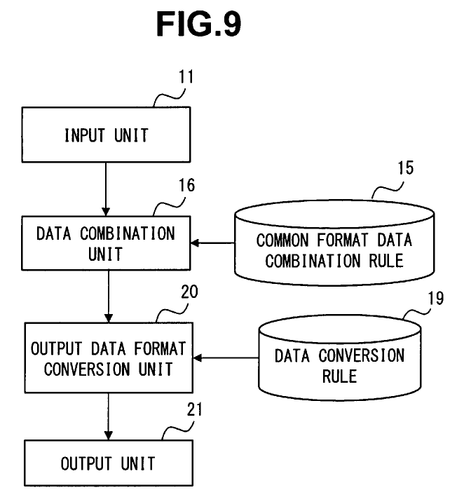

FIG. 9 is a block diagram showing still another example of the functional blocks of the information combining device. The information combining device shown in FIG. 9 comprises an input unit 11, a common format data combination rule storage 15, a data combination unit 16, a data conversion rule storage 19, an output data format conversion unit 20, and an output unit 21. The input unit 11, the common format data combination rule storage 15, and the data combination unit 16 have the same functions as those in the second example embodiment.

The data conversion rule storage 19 stores conversion rules for converting to one or more desired data format (output data format) as the output data format. The output data format conversion unit 20 acquires a conversion rule for converting output information (in this example embodiment, a modern design document) to the desired data format from the data conversion rule storage 19. When the data conversion rule storage 19 stores multiple conversion rules, the output data format conversion unit 20 selects from the data conversion rule storage 19 the conversion rule corresponding to both the data format of the output from the data combination unit 16 and the data format of the output information. The output data format conversion unit 20 then converts the data format of the output from the data combination unit 16 into the desired data format according to the selected conversion rule.

The output unit 21 outputs the information of the converted data format.

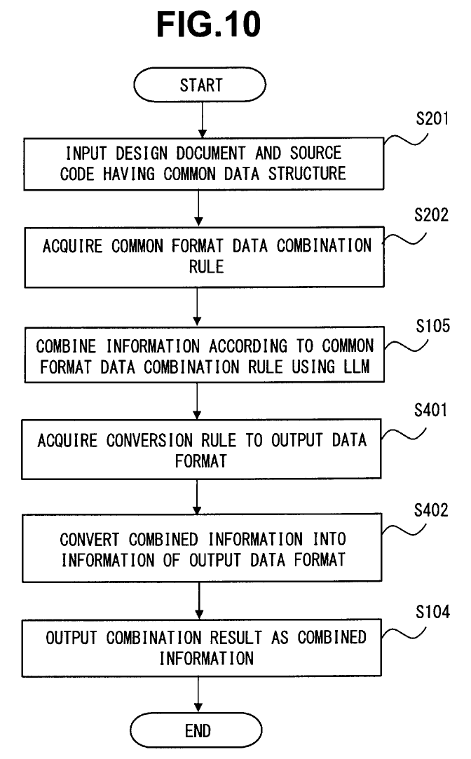

Next, the operation of the information combining device of this example embodiment will be explained with reference to FIG. 10. FIG. 10 is a flowchart showing an example of the operation of the information combining device of this example embodiment.

The processing in steps S201, S202, S103, and S104 is the same as the processing in the second example embodiment shown in FIG. 6.

The output data format conversion unit 20 acquires a conversion rule from the data conversion rule storage 19 for converting the data format into the desired output data format (step S401). Then, the output data format conversion unit 20 converts the data format of the combined result from the data combination unit 16 according to the conversion rule (step S402).

As an example, when the combined result is data in a data structure (data format) utilizing an MVC architecture and the desired output data format is a structured text format, the output data format conversion unit 20 converts the data format utilizing the MVC architecture of the combined result from the data combination unit 16 into the structured text format. Note that the conversion rule for such conversion is acquired from the data conversion rule storage 19.

The output unit 21 outputs the combination result (step S104), similar to the output unit 14 in the above example embodiments. However, in this example embodiment, the data format of the combined result output by the output unit 21 has been converted to the desired output data format.

In this example embodiment, in addition to the effect of the second example embodiment, the following effect can be acquired.

When simply utilizing an LLM, it is conceivable that the information combined by the LLM would be converted to the output format again, for example, by manually using the LLM. However, in this example embodiment, the conversion process to the desired output data format is also automatically performed by the information combining device.

It should be noted that the information combining device of this example embodiment has a configuration where the data conversion rule storage 19 and the output data format conversion unit 20 are added to the information combining device of the second example embodiment. However, the data conversion rule storage 19 and the output data format conversion unit 20 may also be added to the first example embodiment or the third example embodiment.

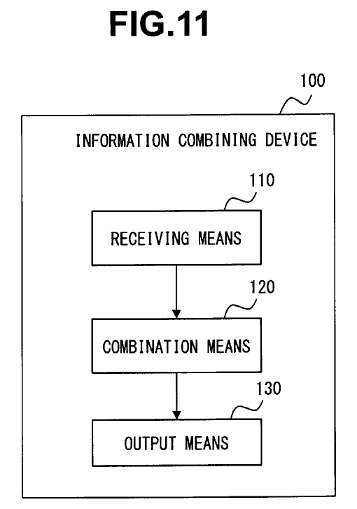

FIG. 11 is a block diagram showing the main part of the information combining device. The information combining device 100 shown in FIG. 11 comprises: receiving means 110 for receiving multiple types of data (in the example embodiment, realized by input unit 11);a combining means 120 (implemented in the example embodiment by data combination units 13, 16, 18) that combines multiple types of data according to rules for combining the multiple types of data, and an output means 130 (implemented in the example embodiment by output units 14, 21) that outputs the combined data.

The present disclosure has been described with reference to example embodiments, but the disclosure is not limited to the above example embodiments. Various modifications may be made to the configuration and operation of the disclosure within the scope of the disclosure that would be understood by those skilled in the art. Furthermore, each example embodiment may be combined with other example embodiments as appropriate.

A part of or all of the above example embodiment may also be described as, but not limited to, the following Supplementary notes.

(Supplementary note 1) An information combining device, comprising:

receiving means for accepting multiple types of data,

combination means for combining the multiple types of data according to a rule for combining the multiple types of data, and

output means for outputting combined data.

(Supplementary note 2) The information combining device according to Supplementary note 1,

wherein the receiving means accepts the multiple types of data having common data format.

(Supplementary note 3) The information combining device according to Supplementary note 2,

wherein rules for combining the multiple types of data include a consistency rule for making the multiple types of data to be consistent,

wherein the information combining device includes extraction means for extracting similarities and differences between accepted multiple types of data, and

wherein the combination means processes extracted similarities and differences according to the consistency rule.

(Supplementary note 4) The information combining device according to any one of Supplementary notes 1 to 3, further comprising means for changing the data format of the combined data.

(Supplementary note 5) The information combining device according to any one of Supplementary notes 1 to 4,

wherein the combination means combines the multiple types of data using an LLM.

The combining means uses an LLM to combine multiple types of data.

(Supplementary note 6) An information combining method, implemented by a processor, comprising:

accepting multiple types of data,

combining the multiple types of data according to a rule for combining the multiple types of data, and

outputting combined data.

(Supplementary note 7) An information combining program causing a computer to execute:

accepting multiple types of data,

combining the multiple types of data according to a rule for combining the multiple types of data, and

outputting combined data.

Some or all of the configurations described in Supplementary notes 2 to 6, that directly or indirectly depend on Supplementary note 1 described above, can be dependent on Supplementary notes 7 and 8 by the same dependency relationship as Supplementary note 1. Further, not limited to Supplementary notes 7 and 8, some or all of the configurations described as Supplementary notes can similarly depend on various hardware, software, various recording means for recording software, or systems, on condition that the above example embodiment are not deviated from.

The present invention has been described with reference to the example embodiments, but the present invention is not limited to the above example embodiments. Various modifications may be made to the configurations and details of the present invention within the scope of the present invention that would be understood by those skilled in the art.

What is claimed is:

1. An information combining device, comprising:
a memory storing software instructions; and
one or more processors configured to execute the software instructions to:
accept multiple types of data,
combine the multiple types of data according to a rule for combining the multiple types of data, and
output combined data.

2. The information combining device according to claim 1,
wherein the one or more processors are configured to execute the software instructions to accept the multiple types of data having common data format.

3. The information combining device according to claim 1,
wherein rules for combining the multiple types of data include a consistency rule for making the multiple types of data to be consistent, and
wherein the one or more processors are configured to execute the software instructions to
extract similarities and differences between accepted multiple types of data, and
process extracted similarities and differences according to the consistency rule.

4. The information combining device according to claim 1,
wherein the one or more processors are configured to execute the software instructions to change the data format of the combined data.

5. The information combining device according to claim 2,
wherein the one or more processors are configured to execute the software instructions to change the data format of the combined data.

6. The information combining device according to claim 3,
wherein the one or more processors are configured to execute the software instructions to change the data format of the combined data.

7. The information combining device according to claim 1,
wherein the one or more processors are configured to execute the software instructions to combine the multiple types of data using an LLM.

8. The information combining device according to claim 2,
wherein the one or more processors are configured to execute the software instructions to combine the multiple types of data using an LLM.

9. The information combining device according to claim 3,
wherein the one or more processors are configured to execute the software instructions to combine the multiple types of data using an LLM.

10. The information combining device according to claim 4,
wherein the one or more processors are configured to execute the software instructions to combine the multiple types of data using an LLM.

11. The information combining device according to claim 5,
wherein the one or more processors are configured to execute the software instructions to combine the multiple types of data using an LLM.

12. The information combining device according to claim 6,
wherein the one or more processors are configured to execute the software instructions to combine the multiple types of data using an LLM.

13. An information combining method, implemented by a processor, comprising:
accepting multiple types of data,
combining the multiple types of data according to a rule for combining the multiple types of data, and
outputting combined data.

14. A non-transitory computer-readable recording medium storing an information combining program, wherein
the information combining program causes a computer to execute:
accepting multiple types of data,
combining the multiple types of data according to a rule for combining the multiple types of data, and
outputting combined data.
